(19) United States
(12) Patent Application Publication
(10) Pub. No.: US 2012/0049788 A1
(43) Pub. Date: Mar. 1, 2012

(54) CHARGE MODULE

(75) Inventors: Jong Man KIM, Gyeonggi-do (KR); Seog Moon CHOI, Seoul (KR); Kyu Bum HAN, Gyeonggi-do (KR)

(73) Assignee: SAMSUNG ELECTRO-MECHANICS CO., LTD.

(21) Appl. No.: 13/018,806

(22) Filed: Feb. 1, 2011

(30) Foreign Application Priority Data
Aug. 30, 2010 (KR) 10-2010-0084159

(51) Int. Cl. H02J 7/00

(52) U.S. Cl. 320/107

(57) ABSTRACT

Disclosed herein is a charge module for charging a high-capacity battery.

The charge module according to the exemplary embodiment of the present invention includes: a heat sink; a fan cover covering the top of the heat sink; a fan mounted on the upper center of the fan cover; and a heat pipe inserted into the side wall of the heat sink to dissipate heat from the side wall of the heat sink through the circulation of refrigerants.

### CROSS REFERENCE TO RELATED APPLICATION

This application claims the benefit of Korean Patent Application No. 10-2010-0084159, filed on Aug. 30, 2010, entitled “Charge Module,” which is hereby incorporated by reference in its entirety into this application.

### BACKGROUND OF THE INVENTION

1. Technical Field

The present invention relates to a charge module for charging a high-capacity battery, and more particularly, to a charge module capable of providing a radiant heat area of a heat sink by extending a fan cover on the side of the heat sink and inserting a heat pipe into the side of the heat sink.

2. Description of the Related Art

At present, gasoline or diesel are used as the main power source of a vehicle, but in recent years, an electric vehicle using a rechargeable battery as the main power source has appeared due to the exhaustion of resources while considering the environment-friendly trend as the main motto.

Further, a hybrid electric vehicle (HEV) was produced before evolving to the electric vehicle, and the hybrid vehicle is called a vehicle using a battery as an auxiliary power supplied by battery on a power device by the existing gasoline engine.

The change absolutely requires a high-voltage charge module which is rapidly chargeable in the battery by using an external power supply in addition to a small-sized high-capacity battery. The charge module is developed on the basis of the existing DC-DC converter, which is developed in the form of equipment including an electric circuit, but a power loss sensitively changes the efficiency of the charge module due to a rapid increase in output capacity.

Since the power loss is related with a heat dissipation amount of a heat generation element mounted in the charge module, the reliability of the charge module may be deteriorated when the heat generation element is not sufficiently cooled.

When voltage of AC 100/220V, which is a general home voltage, is applied to the charge module, the general charge module is used for rapid charging with the voltage of the battery by using a battery management system (BMS) through a boost-up process in the charge module. A heat dissipation design to maximally cool the heat generation element mounted on the charge module is absolutely required in order to reduce heat loss generated from the charge module for rapid and high-capacity charging.

### SUMMARY OF THE INVENTION

An object of the present invention is to provide a charge module which can easily cool a heat generation element mounted on the inner surface of a heat sink as well as mount the heat generation element on the inner surface of the heat sink by using a power semiconductor element used as a main component of the charge module, by using the heat sink as an external case of the charge module in order to smoothly discharge heat discharged to the outside as the loss of the power semiconductor element, extending a fan cover to the side of the heat sink for more efficiently cooling a plurality of heat generation elements mounted in the heat sink or inserting a heat pipe into the side of the heat sink to expand a radiant heat area of the heat sink.

According to an exemplary embodiment of the present invention, there is provided a charge module, including: a heat sink; a fan cover installed to cover the exterior of the heat sink and including a side extended portion forming the side surface of the heat sink and a predetermined separation space; and a fan mounted on the upper center of the fan cover.

The heat sink may also serve as a casing, embed an electric circuit for charging a battery and a power converting component such as a BMS connected to the circuit therein, and include a plurality of cooling pins which are projected to the outside.

Further, in the heat sink, a heat generation element attached onto a substrate therein may be mounted to contact the inner side wall and heat discharged from the heat generation element may also be heat-dissipated to the outside through the side wall of the heat sink.

In this case, the side wall of the heat sink is covered with a side extended portion of the fan cover and cooling air which flows by the fan to compulsorily cool the air of the heat sink through a separation space formed between the side wall of the heat sink and the side extended portion of the fan cover to efficiently cool the heat generation element which contacts the heat sink.

The heat generation element may be a power semiconductor element such as an MOSFET, an IGBT, or a diode and the heat generation element may be driven by being connected through an electric circuit to serve to convert AC power applied to the charge module to DC power.

According to another exemplary embodiment of the present invention, there is provided a charge module, including: a heat sink; a fan cover covering the top of the heat sink; a fan mounted on the upper center of the fan cover; and a heat pipe inserted into the side wall of the heat sink to dissipate heat from the side wall of the heat sink by the circulation of refrigerants.

The heat pipe may be inserted into the side wall so that the upper end of the heat pipe is projected to the top of the side wall of the heat sink and a plurality of pins may be coupled onto the top of the heat pipe. In this case, the pins may be mounted to be perpendicular to the upper end of the heat pipe.

### BRIEF DESCRIPTION OF THE DRAWINGS

FIG. 1 is a cross-sectional view of a charge module according to a first exemplary embodiment of the present invention; and

FIG. 2 is a cross-sectional view of a charge module according to a second exemplary embodiment of the present invention.

### DESCRIPTION OF THE PREFERRED EMBODIMENTS

Matters relating to an operational effect including a technical configuration for the object of a charge module according to the present invention will be apparently understood by a detailed description referring to the accompanying drawings showing the preferred embodiments of the present invention.

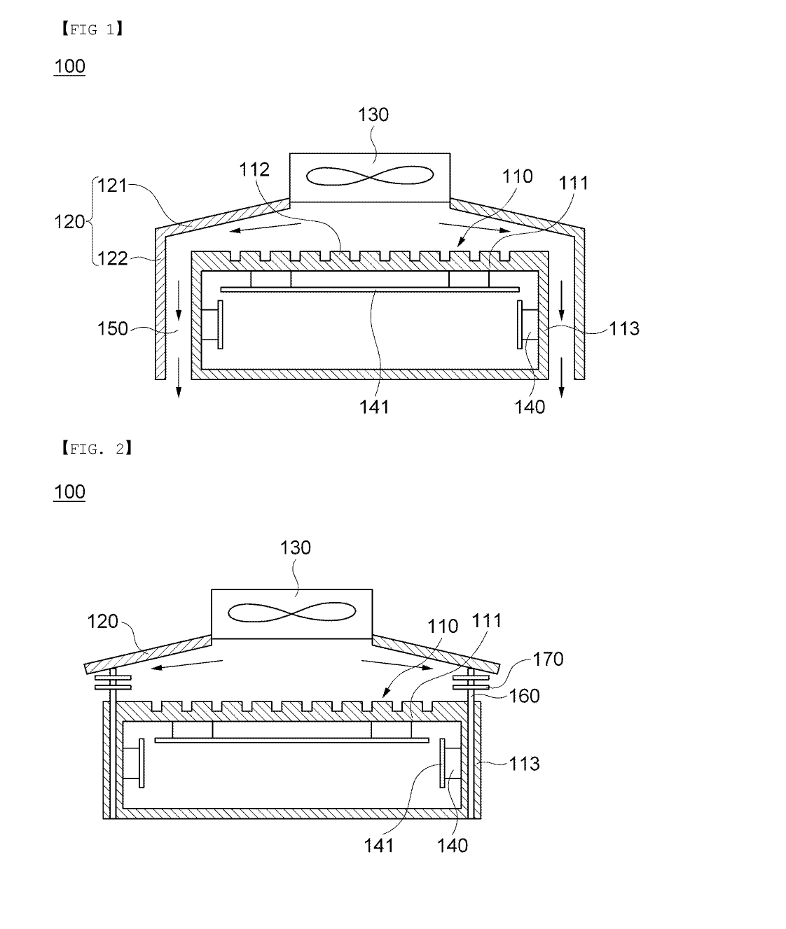

First, FIG. 1 is a cross-sectional view of a charge module according to a first exemplary embodiment of the present invention.

As shown in the figure, the charge module 100 according to the exemplary embodiment may include a heat sink 110, a fan cover 120 installed to cover the exterior of the heat sink 110, and a fan 130 installed at the upper center of the fan cover 120.

The heat sink 110 is overall cooled by driving the fan 130 mounted on the top thereof and the heat sink 110 is overall air-cooled while the cooling air discharged from the fan 130 flows to the side from the top of the heat sink 110.

The heat sink 110 may include a box-type casing embedding an electric circuit and a power converting electronic component which is circuit-connected therein. A plurality of cooling pins 112 are projected on the sides and top other than the bottom to improve a heat dissipation property.

Further, a heat generation component including the heat generation element 140, a coil, or the like mounted on a substrate 141 are mounted in the heat sink 110 while one surface of the heat generation component contacts the inner surfaces of the upper wall 111 and the side walls 113. Therefore, cooling is performed by the heat dissipation function of the heat sink 110.

The heat generation component may be configured by any one of a resonance coil, a PFC coil, and a transformer.

In this case, an opposite surface to a surface of the heat generation element 140, which is mounted on the substrate 141, contacts each inner wall surface of the heat sink 110 so that the heat generation element 140 dissipates heat through the heat sink 110, when the heat generation element 140 is primarily constituted by a high heat dissipation element and mounted on the substrate 141. The heat generation element 140 may be constituted by a power semiconductor element such as a MOSFET, an IGBT, or a diode and each device is connected and driven by the electric circuit on the substrate 141 to serve to convert AC power applied to the charge module from the outside into DC power.

The heat generation element 140 of the power semiconductor element suffers a loss while being driven in order to convert the AC power applied to the charge module to the DC power, the heat generation element 140 generates heat as much as the generated loss, and the larger the loss is, the more the generated heat is. Therefore, real-time cooling is further required.

As a result, as described in the related art, since a structure to compulsorily cool even the side of the heat sink 110 should be adopted in order to more efficiently perform heat dissipation of the heat generation element 140 mounted in the heat sink 110, the side extended portion 122 acquired by the side portion of the fan cover 120 covering the exterior of the heat sink 110 to the lower side portion of the heat sink 110 is formed to allow cooling air discharged from the upper fan 130 to flow up to the lower side portion of the heat sink 110.

For this, the fan cover 120 coupled to support the fan 130 mounted on the top of the heat sink 110 may be constituted by an upper cover 121 covering the top of the heat sink 110 and the side extended portion 122 extending from the side to the bottom of the upper cover 121. A predetermined separation space 150 may be formed between the side of the heat sink 110 and the side extended portion 122.

In this case, the cooling air discharged from the upper fan 130 on the top of the heat sink 110 compulsorily flows from the top to the side of the heat sink 110 as shown in FIG. 1 and flows to the separation space 150 between the side of the heat sink 110 and the side extended portion 122 of the fan cover 120 to cool the heat generation element 140 which contacts the inner surfaces of the side walls 113 of the heat sink 110.

That is, when the cooling air discharged from the fan 130 through the fan cover 120 coupled to cover the outer peripheral surface of the heat sink 110 flows, the separation space 150 formed between the heat sink 110 and the side extended portion 122 of the fan cover 120 serves as an air duct to cool all the side surfaces including the top of the heat sink 110, thereby improving cooling efficiency.

Meanwhile, FIG. 2 is a cross-sectional view of a charge module according to a second exemplary embodiment of the present invention.

In a following detailed description of the exemplary embodiment, the same components as the first exemplary embodiment will not duplicately be described and the same reference numerals refer to the same components.

As shown in the figure, the charge module 100 according to the exemplary embodiment may include a heat sink 110, a fan cover 120 covering the top of the heat sink 110 and having a fan 130 mounted on the upper center thereof, and a heat pipe 160 inserted into the side wall of the heat sink 110.

Similar to the first exemplary embodiment, the heat sink 110 includes a box-type casing embedding an electric circuit and a power converting electronic component which is circuit-connected therein. A plurality of heat generation elements 140 are mounted on a substrate 141, wherein one surface of the heat generation element 140 is coupled with the bottom surface of the top or an inner side surface of the side wall. Hereinafter, a detailed description duplicated with the heat sink 110 of the first exemplary embodiment will be omitted.

Further, the heat pipe 160 is vertically penetrated into the side wall of the heat sink 110. As refrigerants including cooling water are circulated in the heat pipe 160, the heat generation element 140 which contacts the inner surface of the side wall 113 is cooled by heat dissipation from the side wall 113.

The heat pipe 160 is inserted into the side wall 113 of the heat sink 110 so that the upper end of the heat pipe 160 is projected on the top of the side wall 113. A plurality of pins 170 are coupled onto the upper end of the heat pipe 160 which is projected on the top of the side wall of the heat sink 110 to be perpendicular to the heat pipe 160.

In this case, the pins 170 serve to improve the heat dissipation property of the side wall 113 of the heat sink 110 through the heat pipe 160. The pins 170 contact cooling air which flows through the fan 130 on the top of the heat sink 110 to more rapidly cool the heat pipe 160 through the pins 170, as a result, the cooling efficiency of the side wall 113 of the heat sink 110 may further be improved.

Since the cooling performance may be improved only by maximally increasing the contact area of the pins 170 which contact the cooling air flowing on the top of the heat sink 110, it is preferable to increase the number of pins 170 or the area of the pins 170.

Further, in the case of the charge module according to the exemplary embodiment, while the heat pipe 160 is inserted into the side wall 113 of the heat sink 110 and the plurality of pins 170 are mounted on the upper end thereof, the side extended portion 122 of the fan cover 120 extends to the side surface of the heat sink 110 as described in the first exemplary embodiment to increase the cooling efficiency of the heat sink 110.

In the charge module 100 according to the first exemplary embodiment and the second exemplary embodiment, since the heat generation element 140 is attached onto the inner surface of the side wall 113 in addition to the bottom of the upper wall 111 to dissipate heat, degree of freedom in the installation of the heat generation element 140 in the heat sink 110 can be improved and since the installation space extends to the side, short-circuit due to the contact of the heat generation element can be prevented.

Further, since the contact area of the cooling air increases, the overall cooling efficiency of the heat sink 110 can be improved.

As described above, according to exemplary embodiments of the present invention, as a side wall of a heat sink can be cooled by the flow of cooling air through a side extended portion of a fan cover and a heat pipe directly inserted into the side wall, a heat generation element is cooled through the inner surface of the side wall in addition to the bottom of an upper wall of a heat sink, such that a degree of freedom in the installation of the heat generation element mounted in the heat sink can be improved and as an installation space of the heat generation element extends to the side, it is possible to prevent a short circuit by the contact of the heat generation element.

Further, cooling air through a fan directly contacts the side of the heat sink through a side extended portion of an air duct type and the heat pipe inserted into the side wall of the heat sink is cooled by pin contact, such that an area in which the heat sink contacts the cooling air increases, as a result, it is possible to improve the overall cooling efficiency of the heat sink.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

What is claimed is:

1. A charge module, comprising:
a heat sink;
a fan cover installed to cover the exterior of the heat sink and including a side extended portion forming the side surface of the heat sink and a predetermined separation space; and
a fan mounted on the upper center of the fan cover.

2. The charge module according to claim 1, wherein the heat sink also serves as a casing, embeds an electric circuit for charging a battery and a power converting component of a BMS connected to the circuit therein, and includes a plurality of cooling pins which are projected to the outside.

3. The charge module according to claim 2, wherein in the heat sink, heat generation components including a coil in addition to a heat generation element attached onto a substrate are mounted to contact the inner side wall and heat discharged from the heat generation element or heat generation components is heat-dissipated to the outside through the side wall of the heat sink.

4. The charge module according to claim 3, wherein the heat generation element is a power semiconductor element such as a MOSFET, an IGBT, or a diode.

5. The charge module according to claim 3, wherein the heat generation component is constituted by any one of a resonance coil, a PFC coil, a transformer, and a core.

6. A charge module, comprising:
a heat sink;
a fan cover covering the top of the heat sink;
a fan mounted on the upper center of the fan cover; and
a heat pipe inserted into the side wall of the heat sink to dissipate heat from the side wall of the heat sink through the circulation of refrigerants.

7. The charge module according to claim 1, wherein in the heat sink, heat generation components including a coil in addition to a heat generation element attached onto a substrate are mounted to contact the inner side wall and heat discharged from the heat generation element or heat generation components is heat-dissipated to the outside through the side wall of the heat sink.

8. The charge module according to claim 1, wherein the heat pipe is inserted into the side wall so that the upper end of the heat pipe is projected to the top of the side wall of the heat sink and a plurality of pins are coupled onto the top of the heat pipe.

9. The charge module according to claim 8, wherein the pins are coupled to the upper end of the heat pipe to be perpendicular to the upper end of the heat pipe.

10. The charge module according to claim 7, wherein the heat generation element is a power semiconductor element such as a MOSFET, an IGBT, or a diode.

11. The charge module according to claim 1, wherein the fan cover includes a side extended portion which extends to the side surface of the heat sink on the side of the fan cover.

12. The charge module according to claim 7, wherein the heat generation component is constituted by any one of a resonance coil, a PFC coil, a transformer, and a core.
